(19) United States
(12) Patent Application Publication
(10) Pub. No.: US 2008/0265548 A1
(43) Pub. Date: Oct. 30, 2008

(54) Multi-purpose chair for the disabled

(76) Inventors: Bruce R. Hammer, San Rafael, CA (US); David F. Gaskell, Vallejo, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/789,345

(22) Filed: Apr. 24, 2007

(51) Int. Cl. A61G 5/08; B23P 11/00

(52) U.S. Cl. 280/650; 29/428

(57) ABSTRACT

The present invention is directed to a multi-purpose chair for the disabled that can be used as a passive wheelchair designed to be pushed by an individual to transport the occupant in a sitting position. By adjusting the heights of the legs, it will fit over conventional or handicapped commodes. Removing the legs with locking casters and inserting the stationary legs, the device can be used as a conventional chair. Additionally it can used a commode chair/raised toilet seat/safety frame. The device can also be used in a shower or by lifting one of the cantilevered armrests, and attaching the side bench, it can be used beside a bathtub. Covering the seat with the elastic seat-cover, the device can be used to transport individuals in public places without revealing the toileting applications. The novelty is that this all can be easily assembled or disassembled and carried in a FAA dimensionally compliant carrying case.

### FIELD OF THE INVENTION

The multi-purpose chair for the disabled relates to devices used by handicapped or physically impaired individuals. More specifically this patent deals with a unique adjustable chair adapted with wheels or stationary legs and a side bench that when disassembled will conveniently fit into a FAA dimensionally compliant carrying case that will go into the overhead compartments on aircraft and through the openings of the x-ray machines at the airports. It can be used on-board aircraft as an aisle chair making trips to the restroom possible. Because the invention can be brought on-board aircraft (carry-on luggage) having to check this important piece of equipment is eliminated: lack of security at most airport baggage claim areas provides an easy environment for theft. Also the invention gets the person with a disability closer to the norm: skipping the luggage check-in/hope it doesn't get stolen, etc.

### BACKGROUND OF THE INVENTION

A significant number of the people are confined to move about in wheelchairs all or part of the time and face many challenges. While some of their problems are solved by the limited mobility afforded them through the conventional wheelchair, other problems stem from the design, the weight and the amount of storage space required for cumbersome conventional wheelchairs. Using the toilet facilities is especially difficult for these individuals and many specialty devices have been devised for different purposes, but they are not easily transported and are generally designed for one specific purpose.

The mobility of disabled persons has been increasing in recent years to include not only social and business life but travel as well. Where once a disabled individual was expected to restrict travel away from home, today these special people are traveling around the world to conduct business or taking vacations. Generally this need for travel mobility felt by the disabled has been frustrating due to the lack of proper facilities and equipment aboard transportation vehicles, at hotels and resorts. Hence narrow aisle ways; small lavatories, small storage areas and restricted use of transportation vehicle facilities have inhibited travel by the disabled communities.

Hotels, resorts and convention centers generally have courtesy wheelchairs that are provided or can be rented for their guests, but they are limited due to the expense and the space required for storing the cumbersome devices. The permanently or temporally disabled individuals at these locations are usually accompanied by other guests and do not necessarily require a conventional wheelchair where a passive wheelchair without the large drive wheels will work well. These passive wheelchairs generally have much smaller rear wheels than the active wheelchair and include handle bars attached to the back seat of the wheelchair for the individual to grip while pushing the passive wheelchair. The passive wheelchairs are more compact and can negotiate through confined areas and narrow passageways better then the larger wheelchairs.

This patent describes a new and unique multi-purpose chair for the disabled that can be used as a passive wheelchair designed to be pushed by an individual to transport the occupant in a sitting position. By adjusting the heights of the legs, it will fit over conventional or handicapped commodes. Removing the legs with locking casters and inserting the stationary legs, the device can be used as a conventional chair. Additionally it can used a commode chair/raised toilet seat/safety frame. The device can also be used in a shower, or by lifting one of the cantilevered armrests and attaching the side bench, it can be used beside a bathtub. Covering the seat with the elastic seat-cover, the device can be used to transport individuals in public places, down narrow isles and passageways without revealing the toileting applications. The novelty is that this all can be easily assembled or disassembled and carried in a FAA dimensionally compliant carrying case. The multi-purpose chair for the disabled can be manufactured inexpensively and easily stored in confined areas. Hotels, resorts and convention centers can have a greater quantity of devices that will perform multiple important tasks, available for their guests, and take up much less storage space. The multi-purpose chair for the disabled can be easily used in private homes where there are often more confined spaces to care for the disabled. Elderly care facilities are required to have wheel chairs along with many other devices for caring for the patients where this single device can take the place of several of the toileting devices along with supplying a passive wheelchair.

Numerous innovations have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the difference between the features of the present invention and those of the prior art.

U.S. Pat. No. 4,415,177 of Thomas K. Hale describes a folding wheelchair having as its basic elements; of a frame, folding backrest, removable headrest, set of rotatable footpads, a set of rotatable arms, a set of four wheels, and a set of foldable handles carried on a pair of slidable and recessing arms. The wheelchair is rendered foldable via a spider mechanism comprising a body and four leg elements. The end portions of the leg elements are pivotally secured to the frame. Folding and unfolding of the chair is carried out by use of a handle, which rotates a set of cams. When the handle is in the horizontal or “lock” position, the central portions of the leg elements are locked in the wheelchair “unfolded” condition. When the handle is in the vertical or “unlock” position, the leg elements are free to slide along a set of guide slots, permitting the wheelchair to be folded.

This patent describes a folding passive wheelchair that emphasizes the need for a narrow passive wheelchair that can be manipulated through tight passageways, but lacks the additional commode, shower and bathtub features. The device has also not been designed to fold small enough to be carried in a FAA dimensionally compliant carrying case.

U.S. Pat. No. 5,263,728 of Nathalal G. Patel describes a low profile wheelchair that includes first and second frame portions that may be selectively spaced apart in an operative position and brought together in a stored position. Armrests, seat back, and footrests are each pivotally mounted to the frame portions to minimize the height and length of the wheelchair in a storage position.

This patent describes a low profile passive wheelchair that has been designed to function well within the confines of an aircraft by folding together, but lacks the additional commode, shower and bathtub features. It does not clearly define that it can be disassembled to fit into a FAA dimensionally compliant carrying case or through the opening of the airport x-ray machine.

U.S. Pat. No. 5,373,591 of Rick L. Myers describes a shower-commode chair and bathtub transfer track that can be connected together to transfer a person on a sliding chair seat between the chair and the tub area of a bathtub in a seated position without being lifted from the seat. The chair has an adjustable height frame supported on wheels and a pair of horizontal channels secured in parallel spaced relation extending from side to side. A seat is supported on rollers in the horizontal channels. The bathtub transfer track has a pair of elongate channels secured in parallel spaced relation to extend transversely from one side of the bathtub to the other on the top surfaces of the bathtub walls and span the open area of the bathtub to receive and support the seat. Removable arm members on the chair frame retain the seat on the chair frame when attached and allow movement of the seat when removed. A removable backrest connected to the seat moves with the seat. The transfer track is adjustable to correspond with the chair height, adjustable angularly relative to a horizontal plane to facilitate drainage, and adjustable to fit bathtubs of various widths. The chair may be used alone as a commode chair, and the track with the seat supported thereon may be used independently of the chair. Optional wheel, seat, and frame arrangements convert the chair either to an occupant propelled multi-purpose chair capable of passing through a standard bathroom doorway or, to an occupant propelled wheelchair.

This patent describes a shower-commode chair and bathtub transfer track that can be connected together to transfer a person on a sliding chair seat between the chair and the tub area of a bathtub. This device satisfies the bathtub and commode applications, but does not supply the stationary legs required for using in a showering process. It cannot be disassembled to fit into a FAA dimensionally compliant carrying case and could not be conveniently used in hotels and resorts.

U.S. Pat. No. 5,517,704 of Richard J. Dagostino describes a combined commode and shower chair apparatus, comprising: a base section; a seat section adapted to rest on the base section; and an outrigger section removably attachable to the base section. The seat section is slidable from the base section onto the outrigger section for transferring a person in the seat section over a standard bathtub for taking a shower.

This patent describes another combined commode and shower chair apparatus with an outrigger section removably attachable to the base section. This device also satisfies the bathtub and commode applications, but does not supply the stationary legs required for using in a showering process. It cannot be disassembled to fit into a FAA dimensionally compliant carrying case and could not be conveniently used in hotels and resorts.

U.S. Pat. No. 6,623,022 of Pascal Malassignc et al. describes a foldable frame wheelchair that has an opening at the lower rear part thereof for receiving a commode or a tray, which supports a removable pail. The seat has front and side cutouts to provide under seat access dual density supporting foam. The seat also has laterally projecting wings at the front thereof to facilitate lateral transfer of a patient. The armrests at each side of the wheelchair pivot upwardly and rearwardly of the chair. Locking members are provided for locking each arm support in its lowered position; and a release lever can be pushed to unlock each arm support. A pair of footrest supports are each contoured so as not to have any sharp edges and are provided with non-slip surfaces and a drain hole. Each footrest support is pivoted to a split block which is slidable vertically along an arm. The block can be tightened and loosened by a lever. A heel and ankle support is pivotally mounted at the front of the chair and is movable from a depending stored position to a generally horizontal position where it is retained for supporting the heel of a user. The push rims are provided with a non-slip surface and the diameter thereof is increased to provide a better grip. Orthogonal hinges mounted to side frame members allow the frame to fold to a small volume. A carrying bag is provided for ease of transport.

This patent describes a foldable frame of the conventional wheelchair with large drive wheels that has an opening at the lower rear part thereof for receiving a commode. It cannot be disassembled to fit into a FAA dimensionally compliant carrying case and could not be conveniently for a wide variety of applications or used in hotels and resorts.

It has been found through the endeavors of the inventor and the patent search that there is no apparatus on the market and no apparent patents reviewed that have similar characteristics to the unique multi-purpose chair for the disabled.

### SUMMARY OF THE INVENTION

The principal advantage of the multi-purpose chair for the disabled is to supply a multi-purpose device that can be stored in a FAA dimensionally compliant small carrying case.

Another advantage of the device is that it can easily be assembled and disassembled.

Another advantage of the device is that it will work as a stationary chair or a passive wheelchair.

Another advantage of the device is that it has height adjustable legs with locking casters or height adjustable stationary legs.

Another advantage of the device is that it will fit over varying sizes of commodes.

Another advantage of the device is that with the stationary legs it can be used as a shower chair.

Another advantage is the device with the stationary legs and the side bench attached, can be used beside a bathtub for bathing.

And still another advantage of the multi-purpose chair for the disabled is that it will cost much less to manufacture than a conventional wheelchair.

A further advantage is that this multi-purpose chair for the disabled can be available at hotels, resorts and convention centers.

And yet another advantage of this multi-purpose chair for the disabled is to add a new and unique much needed device to the area of the care, convenience and comfort of the disabled.

And yet a further advantage of this multipurpose chair for the disabled is that it is well suited for using toilet facilities, which is especially difficult for disabled individuals, and whereas many specialty devices have been devised for different purposes, most are not easily transported, and have been generally designed for one specific purpose, unlike the present invention.

These together with other advantages of the multi-purpose chair for the disabled, along with the various features of novelty, which characterize the device, are pointed out with particularity in the claims annexed to and forming a part of this disclosure. For a better understanding of the multi-purpose chair for the disabled, its operating advantages and the specific objects attained by its uses, reference should be made to the accompanying drawings and descriptive matter in which there are illustrated preferred embodiments of the device. There has thus been outlined, rather broadly, the more important features of the device in order that the detailed description thereof that follows may be better understood, and in order that the present contribution to the art may be better appreciated. There are additional features of the multi-purpose chair for the disabled that will be described hereinafter and which will form the subject matter of the claims appended hereto.

The preferred embodiment of the multi-purpose chair for the disabled will consist of fourteen separate parts that when assembled will form the basic device. These fourteen parts will fit easily within a FAA dimensionally compliant carrying case. The device will consist of four adjustable length leg members with casters, two footrest members, a folding seat assembly, and two cantilevered armrest assemblies, two back support posts, a fabric covered padded backrest and two handgrip units. The addition of a side bench with adjustable bathtub support legs and four stationary adjustable length legs are added features. A unique feature is the folding seat assembly with a rugged structural frame and padded seat cushions that locks in the open position and fold in half for storage. An elastic padded seat cover will cover the toileting feature when required.

An alternate embodiment of the folding seat assembly will be the folding seat assembly with an open front having a U-shaped support brace. This seat assembly provides more under seat access to enable a patient to place their hands in the proper position for various bathing and toilet procedures.

An alternate embodiment of the folding seat assembly will be the folding seat assembly with an open front without any structure in the way. Adequate strength is provided by means of double tubing and hinges at the rear of the frame. This seat assembly provides more under seat access to enable a patient to place their hands in the proper position for various bathing and toilet procedures. Moreover, additional rigidity will be provided by the doubled width of the curved side rails.

With respect to the above description then, it is to be realized that the optimum dimensional relationships for the parts of the multi-purpose chair for the disabled will include variations in size, materials, shape, form, function and manner of operation, assembly and use, are deemed readily apparent and obvious to one skilled in the art. All equivalent relationships to those illustrated in the drawings and described in the specification intended to be encompassed by the present multi-purpose chair for the disabled. Therefore, the foregoing is considered as illustrative only of the principles of the device. Further, since numerous modifications and changes will readily occur to those skilled in the art, it is not desired to limit the device to the exact construction and operation shown and described, and accordingly, all suitable modifications and equivalents may be resorted to, falling within the scope of the device.

### BRIEF DESCRIPTION OF THE DRAWINGS

The accompanying drawings, which are incorporated in and form a part of this specification, illustrate embodiments of the multi-purpose chair for the disabled and together with the description, serve to explain the principles of this device.

FIG. 1 depicts an exploded perspective view of the multi-purpose chair for the disabled with the legs having locking casters and the side bench assembly, constructed in accordance with the present invention;

FIG. 2 depicts a perspective view of the under side of the preferred embodiment of the folding seat assembly in the locked open position, constructed in accordance with the present invention;

FIG. 3 depicts a perspective view of the preferred embodiment of the folding seat in the partially folded position, constructed in accordance with the present invention;

FIG. 4 depicts a perspective view of the preferred embodiment of the folding seat in the folded position, constructed in accordance with the present invention;

FIG. 5 depicts a perspective view of the multi-purpose chair for the disabled with the stationary legs including the side bench assembly, constructed in accordance with the present invention;

FIG. 6 depicts a plan view of the multi-purpose chair for the disabled stored in a compact FAA dimensionally compliant carrying case, constructed in accordance with the present invention;

FIG. 7 depicts a perspective view of the bottom of the alternate embodiment of the folding seat assembly with the open front having a U-shaped support brace, constructed in accordance with the present invention; and

FIG. 8 depicts a perspective view of the multi-purpose chair for the disabled incorporating the alternate embodiment of the folding seat assembly with the open front double tubing/hinges at the rear of the frame and doubled width of the curved side rails for additional rigidity, constructed in accordance with the present invention;

### DETAILED DESCRIPTION OF THE PREFERRED EMBODIMENTS

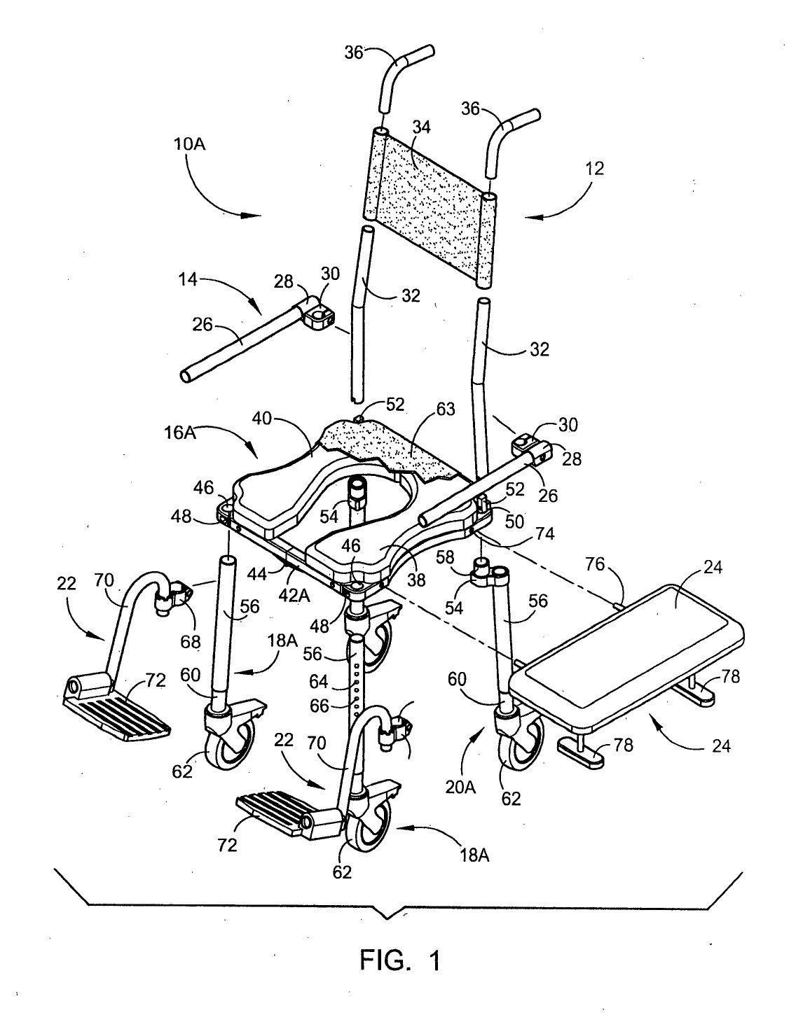

Referring now to the drawings, wherein similar parts of the multi-purpose chair for the disabled 10A and 10B are identified by like reference numerals. There is seen in FIG. 1 an exploded perspective view of the multi-purpose chair for the disabled 10A. This illustration depicts the major assemblies; the chair back rest assembly 12, the cantilevered arm rest assemblies 14, the preferred embodiment of the chair folding seat assembly 16A, the forward adjustable length leg with locking casters 18A, the rear set of adjustable length leg with locking casters 20A, the foot rest assemblies 22 and the side bench assembly 24.

There is one cantilevered arm 12 on each side of the multi-purpose chair for the disabled 10A consisting of an arm rest bar 26 that when pressed into the locking mechanism in the pivot unit 28 will allow the arm rest bar 26 to be moved from the locked down position to the locked up position. The pivot unit 28 is permanently attached to the arm rest bar clamp 30. The arm rest bar clamps 30, clamp onto the two back rest support tubes 32 at either side of the chair creating a framework for the padded back rest 34 to slide over and the two handle bars 36 to slide into. Additionally, arm rest bar clamps 30 slide up and down to provide height adjustment and allow horizontal adjustment of cantilevered arm rest assembly 14.

The preferred embodiment of the chair folding seat assembly 16A consists of a right side padded seat member 38 and a left side padded seat member 40 that are attached to the folding seat frame member 42A. On the preferred embodiment of the chair folding seat assembly 16A there are two hinges 44 one in the front and one in the rear, creating a means for the two halves of the seat assembly 16A to fold for storage. Two front seat frame orifices 46 on the front corners of the seat frame member 42A are a means for the forward adjustable length legs with locking casters 18A to be locked into position by the means of the leg clamping screw 48. At the rear of the seat frame member 42A are two orifices 50 holding the back rest tube mounting members 52 and where the rear set of adjustable length legs with locking casters 20A are mounted. A spreader unit 54 is attached to the distal end of the upper adjustable leg sections 56 with a tubular section 58 that is clamped within the orifices 50 by the means of two additional leg clamping screws 48.

The lower adjustable leg sections 60 have conventional locking casters 62 attached and slides within the upper adjustable leg sections 56. With the spreader units 54 in the spread position the multi-purpose chair for the disabled 10A will easily fit over a conventional or handicapped commode. When the adjustable length legs with locking casters 20A are reversed, the spreader units 54 make the spacing narrower allowing the chair to be manipulated through a more confined area. A padded cover with an elastic band around it 63 can be placed over the chair folding seat assembly 16A to conceal the toileting features of the multi-purpose chair for the disabled 10A.

The forward adjustable length legs with locking casters 18A are displayed extended below the front seat frame orifices 46 illustrating the polarity of small orifices 64 in the upper leg sections 56 and spring loaded locking ball detent 66 in the lower adjustable leg sections 60, used on all the legs for height adjustment. The foot rest assemblies 22 are exploded away from the upper adjustable leg sections 56 where they are attached by the means of the foot rest clamp members 68 which are attached to the foot rest support bars 70. Conventional foot rests 72 are pivotally attached to the distal ends of the foot rest support bars 70.

The side bench assembly 24 has been illustrated exploded away from the chair folding seat assembly 16A where there are side bench attachment orifices 74 on either side of the seat frame member 42A attaching the side bench assembly 24 by the means of the two side bench attaching pins 76. Two height adjustable legs 78 facilitate the adjustment for the height of the chair and the height of the side of the bath tubs used for bathing. The surface of the side bench 80 is at the same elevation as the top of the padded seat member 40 and by raising the adjacent cantilevered arm rest assembly 14, the individual can slide to a position sitting on the edge of the bath tub.

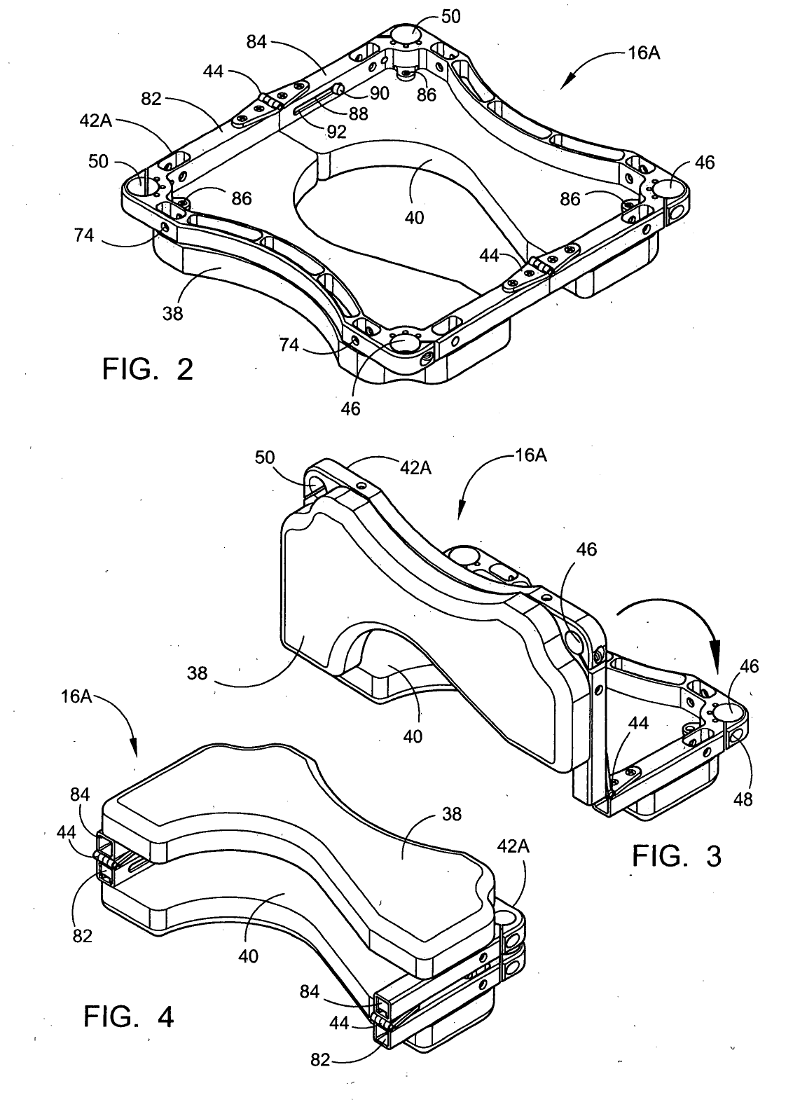

FIG. 2 depicts a perspective view of the under side of the preferred embodiment of the folding seat assembly 16A in the locked open position. The right and left side padded seat members 38 and 40 are attached to the right side and left side 82 and 84 of the seat frame member 42A by the means of the seat attachment screws 86. The center of the frame member 42A is strengthened by the means of a slide bar 88 at the front and rear, that when slid into position extends between the right side and left side 82 and 84 of the seat frame member 42A. This adjustment is made by moving the head of the slide bar knob 90 (here shown as Allen head screws) attached to the slide bar 88 within the guide slots 92.

FIG. 3 depicts a perspective view of the preferred embodiment of the folding seat 16A in the partially folded position while FIG. 4 depicts a perspective view of the preferred embodiment of the folding seat 16A in the folded position.

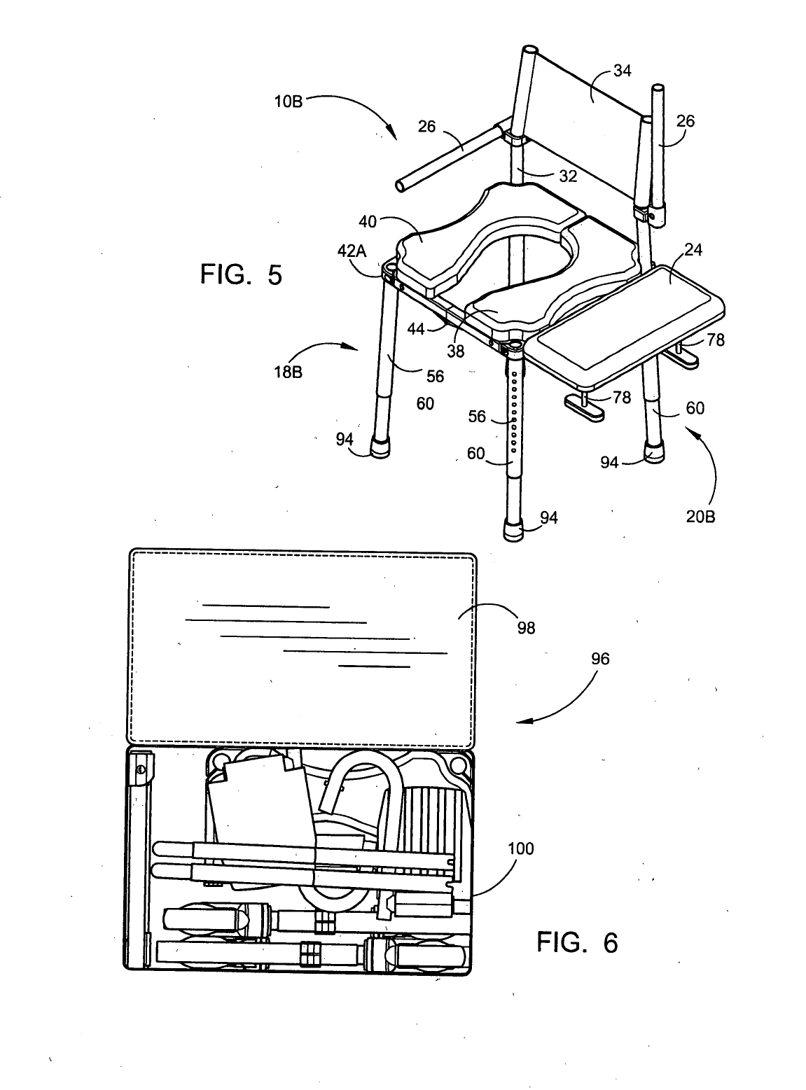

FIG. 5 depicts a perspective view of the multi-purpose chair for the disabled 10B with the stationary legs 18B including the side bench assembly 24. The adjacent arm rest bar 26 is in the raised position allowing the individual to slide over to the edge of the bath tub. Non-slip leg boots 94 (such as conventional crutch tips) are located at the distal ends of the stationary legs 18B to minimize slipping on smooth or wet surfaces.

FIG. 6 depicts a plan view of the multi-purpose chair for the disabled 10A stored in a FAA dimensionally compliant carrying case 96 consisting of a top panel 98 and a lower compartment 100.

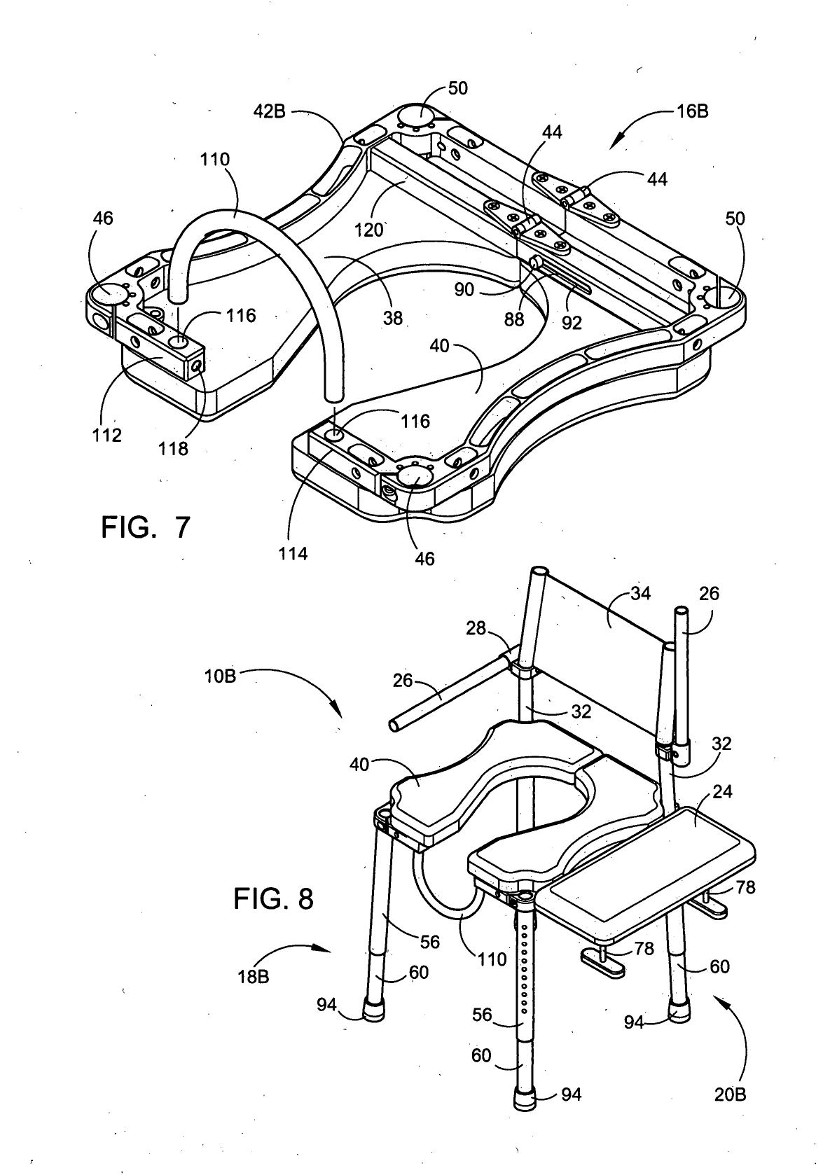

FIG. 7 depicts a perspective view of the bottom of the alternate embodiment of the folding seat assembly 16B with the open front having a U-shaped cross brace 110. The front section of the folding seat frame 42B has been divided into a right side member 112 and left side member 114 with orifices 116 to receive the U-shaped cross brace 110. Set screws 118 at either end of right side member 112 and left side member 114 are tightened against the U-shaped cross brace 110 to hold it in place within orifices 116. A second hinged section 120 as a means for additional support is located at the rear incorporated into the frame 42B with a similar hinge 44, slide bar 88, slide bar knob 90 and guide slot 92.

FIG. 8 depicts a perspective view of the multi-purpose chair for the disabled 10B incorporating the alternate embodiment of the folding seat assembly 16B with the open front and the U-shaped cross brace 110 in position.

The multi-purpose chair for the disabled 10A and 10B shown in the drawings and described in detail herein disclose arrangements of elements of particular construction and configuration for illustrating preferred embodiments of structure and method of operation of the present device. It is to be understood, however, that elements of different construction and configuration and other arrangements thereof, other than those illustrated and described may be employed for providing a multi-purpose chair for the disabled 10A and 10B in accordance with the spirit of this device, and such changes, alternations and modifications as would occur to those skilled in the art are considered to be within the scope of this device as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the multi-purpose chair for the disabled of this application, which is measured by the claims, nor is it intended to be limiting as to the scope of the design in any way.

We claim:

1. A multipurpose chair for the disabled, comprising:
(a) a folding seat frame having four apertures, each aperture located in the four corners of said seat assembly, leg members removably attached to said seat frame, said leg members each having a caster removably attached thereto;
(b) two footrest members removably attached to said leg members, two backrest supports removably attached to said seat frame, two cantilevered armrest assemblies removably attached to said backrest supports, and a backrest removably attached to said backrest supports;
whereby said removable leg members, said removable casters, said removable backrest supports, said removable armrest assemblies, and said removable folding seat frame are disassembled such that all component parts fit into a compact FAA compliant carrying case for transport, then reassembled for use.

2. The multipurpose chair for the disabled, according to claim 1, wherein said folding seat frame includes a pair of hinges to facilitate folding, and is lockable in the open position for stability during use.

3. The multipurpose chair for the disabled, according to claim 1, wherein said folding seat frame includes a central opening for facilitating toileting and showering activities by the user.

4. The multipurpose chair for the disabled, according to claim 3, wherein said folding seat frame further includes a U-shaped support brace.

5. The multipurpose chair for the disabled, according to claim 1, wherein said folding seat frame includes one or more padded seat cushions.

6. The multipurpose chair for the disabled, according to claim 1, wherein said leg members are height adjustable.

7. The multipurpose chair for the disabled, according to claim 1, wherein said leg members each have a caster removably attached thereto, have the casters removed and in place of the removed casters have non-slip leg boots attached thereto.

8. The multipurpose chair for the disabled, according to claim 1, wherein said backrest removably attached to said backrest supports further include handle bars removably attached to said backrest.

9. The multipurpose chair for the disabled, according to claim 1, wherein said folding seat frame further includes a side bench assembly removably attached thereto.

10. The multipurpose chair for the disabled, according to claim 1, further comprising a compact carrying case wherein said compact carrying case is a compact FAA compliant carrying case and whereby said removable leg members, said removable casters, said removable backrest supports, said removable armrest assemblies, and said removable folding seat frame are disassembled such that all component parts fit into said compact FAA compliant carrying case for transport, then reassembled for use.

11. A method for making a multipurpose chair for the disabled, comprising the steps of:
(a) providing a folding seat frame having four apertures, each aperture located in the four corners of said seat assembly, leg members removably attached to said seat frame, said leg members each having a caster removably attached thereto; and
(b) providing two footrest members removably attached to said leg members, two backrest supports removably attached to said seat frame, two cantilevered armrest assemblies removably attached to said backrest supports, and a backrest removably attached to said backrest supports;
whereby said removable leg members, said removable casters, said removable backrest supports, said removable armrest assemblies, and said removable folding seat frame are disassembled such that all component parts fit into a compact FAA compliant carrying case for transport, then reassembled for use.

12. The method for making a multipurpose chair for the disabled, according to claim 12, wherein said step of providing a folding seat frame includes the step of providing a folding seat frame wherein said folding seat frame includes a pair of hinges to facilitate folding, and is lockable in the open position for stability during use.

13. The method for making a multipurpose chair for the disabled, according to claim 11, wherein said step of providing a folding seat frame includes the step of providing a folding seat frame wherein said folding seat frame includes a central opening for facilitating toileting and showering activities by the user.

14. The method for making a multipurpose chair for the disabled, according to claim 13, wherein said step of providing a folding seat frame including a central opening for facilitating toileting and showering activities by the user further includes providing a folding seat frame wherein said folding seat frame further includes a U-shaped support brace.

15. The method for making a multipurpose chair for the disabled, according to claim 11, wherein said step of providing a folding seat frame includes the step of providing a folding seat frame wherein said folding seat frame includes one or more padded seat cushions.

16. The method for making a multipurpose chair for the disabled, according to claim 11, wherein said step of providing leg members removably attached to said folding seat frame further includes the step of providing leg members that are height adjustable.

17. The method for making a multipurpose chair for the disabled, according to claim 11, wherein said step of providing leg members having casters removably attached thereto is replaced with the step of providing leg members having non-slip leg boots attached thereto in place of said casters.

18. The method for making a multipurpose chair for the disabled, according to claim 11, wherein said step of providing a backrest removably attached to said backrest supports further includes the step of providing handle bars removably attached to said backrest.

19. The method for making a multipurpose chair for the disabled, according to claim 11, wherein said step of providing a folding seat frame further includes the step of providing a folding seat frame wherein said folding seat frame further includes a side bench assembly removably attached thereto.

20. The method for making a multipurpose chair for the disabled, according to claim 11, further comprising the step of providing a compact carrying case wherein said compact carrying case is a compact FAA compliant carrying case and whereby said removable leg members, said removable casters, said removable backrest supports, said removable armrest assemblies, and said removable folding seat frame are disassembled such that all component parts fit into said compact FAA compliant carrying case for transport, then reassembled for use.
